(19) United States
(12) Patent Application Publication
(10) Pub. No.: US 2012/0212931 A1
(43) Pub. Date: Aug. 23, 2012

(54) LIGHT EMITTING DEVICE

(75) Inventors: Junichi KINOSHITA, EHIME-KEN (JP); Yuji TAKEDA, EHIME-KEN (JP); Yoji KAWASAKI, EHIME-KEN (JP); Misaki UENO, EHIME-KEN (JP)

(73) Assignee: HARISON TOSHIBA LIGHTING CORP., IMABARI-SHI (JP)

(21) Appl. No.: 13/370,385

(22) Filed: Feb. 10, 2012

(30) Foreign Application Priority Data
Feb. 22, 2011 (JP) 2011-036434

(51) Int. Cl. F21V 9/16

(52) U.S. Cl. 362/84

(57) ABSTRACT

A light emitting device includes a first light source, an optical waveguide body, a light emitting layer and a first reflection layer. The optical waveguide body includes a first end surface to which light from the first light source is injected, and a second end surface opposed to the first end surface and provided in a light guiding direction of the light. The light emitting layer includes, along the light guiding direction, phosphor particles capable of absorbing the light and emitting wavelength converted light or a light diffusing agent diffusing the light. The first reflection layer is provided on the second end surface and is capable of reflecting part of the light guided in the optical waveguide body. Diffused light from the light emitting layer is emitted to outside of the optical waveguide body.

### CROSS-REFERENCE TO RELATED APPLICATIONS

This application is based upon and claims the benefit of priority from the prior Japanese Patent Application No.2011-036434, filed on Feb. 22, 2011; the entire contents of which are incorporated herein by reference.

### FIELD

Embodiments described herein relate generally to a light emitting device.

### BACKGROUND

Output light from a light source in the ultraviolet-to-visible wavelength range can be mixed with wavelength converted light emitted from phosphor particles having absorbed this output light to obtain e.g. white light, artificial white light, or incandescent color.

If a blue LED chip is covered with a yellow phosphor layer, artificial white light can be obtained as a point light source. On the other hand, if a yellow phosphor layer extended in the light guiding direction of an optical waveguide body is irradiated with blue light guided inside the optical waveguide body, artificial white light can be obtained as a linear light source.

In this case, excitation light (output light of the light source) is absorbed more significantly in the phosphor layer region near the light source. However, with the distance from the light source, the intensity of the excitation light decreases, and absorption in the phosphor layer is reduced. The problem here is that the intensity of artificial white light is higher on the light source side and decreases with the distance from the light source. Furthermore, with the distance from the light source, the chromaticity is also shifted to the yellow side because of the decrease of blue light.

### BRIEF DESCRIPTION OF THE DRAWINGS

FIG. 1A is a schematic sectional view of a light emitting device according to a first embodiment, FIG. 1B is a schematic view showing diffuse emission in which output light is wavelength converted by phosphor particles, and FIG. 1C is a schematic view showing diffuse emission of output light by a light diffusing agent;

FIG. 2A is a graph showing the light intensity distribution of a laser beam, FIG. 2B is a schematic side view showing an incident surface with a large incident region, and FIG. 2C is a schematic side view showing an incident surface with a small incident region;

FIG. 3A is a schematic sectional view of a variation of the first embodiment, FIG. 3B is a schematic view showing light emission by phosphor particles, and FIG. 3C is a schematic view showing emission by a light diffusing agent;

FIG. 4A is a schematic sectional view of a light emitting device according to a second embodiment, FIG. 4B is a schematic sectional view of a light emitting device according to a first variation thereof, and FIG. 4C is a schematic sectional view according to a second variation;

FIG. 5 is a schematic sectional view of a light emitting device according to a third embodiment;

FIG. 6A is a schematic sectional view of a light emitting device according to a fourth embodiment, and FIG. 6B is a schematic sectional view of a variation thereof;

FIGS. 7A to 7E are schematic sectional views showing variations of the shape of the reflection layer;

FIG. 8A is a schematic sectional view of a light emitting device according to a fifth embodiment, FIGS. 8B and 8C are schematic side views as viewed from the light source side, FIG. 8D is a schematic perspective view, and FIG. 8E is a schematic sectional view of a variation;

FIG. 9A is a schematic perspective view of a light emitting device according to a sixth embodiment, and FIGS. 9B to 9E are schematic views showing the lighting region; and

FIG. 10A is a schematic perspective view of a light emitting device according to a seventh embodiment, and FIG. 10B is a schematic sectional view thereof.

### DETAILED DESCRIPTION

In general, according to one embodiment, a light emitting device includes a first light source, an optical waveguide body, a light emitting layer and a first reflection layer. The optical waveguide body includes a first end surface to which light from the first light source is injected, and a second end surface opposed to the first end surface and provided in a light guiding direction of the light. The light emitting layer includes, along the light guiding direction, phosphor particles capable of absorbing the light and emitting wavelength converted light or a light diffusing agent diffusing the light. The first reflection layer is provided on the second end surface and is capable of reflecting part of the light guided in the optical waveguide body. Diffused light from the light emitting layer is emitted to outside of the optical waveguide body.

Embodiments of the invention will now be described with reference to the drawings.

Various embodiments will be described hereinafter with reference to the accompanying drawings.

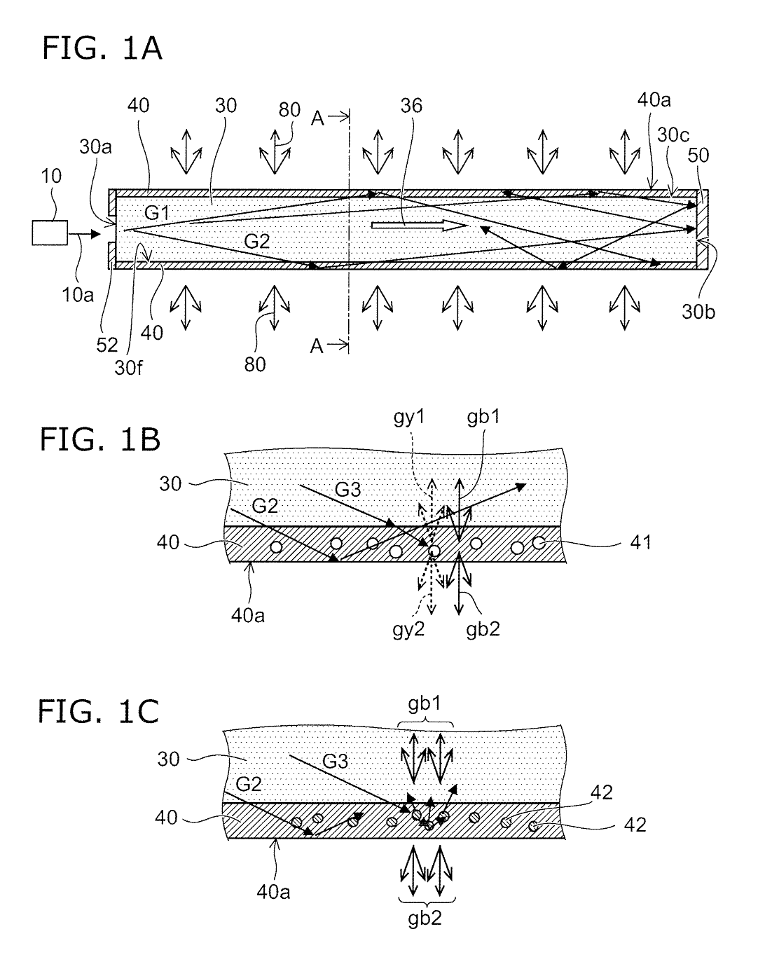

FIG. 1A is a schematic sectional view of a light emitting device according to a first embodiment. FIG. 1B is a schematic view showing diffuse emission in which output light is wavelength converted by phosphor particles. FIG. 1C is a schematic view showing diffuse emission of output light by a light diffusing agent.

In FIG. 1A, the light emitting device includes a light source 10, an optical waveguide body 30 spaced from the light source 10, a light emitting layer 40 including phosphor particles, and a first reflection layer 50 provided on the second end surface 30b of the optical waveguide body 30. The optical waveguide body 30 includes a first end surface 30a, a second end surface 30b, and side surfaces 30c, 30f. The first end surface 30a serves as an incident surface of light 10a emitted from the light source 10. The second end surface 30b is provided with the first reflection layer 50 made of metal or dielectric multilayer film.

The light source 10 can be e.g. an LED (light emitting diode) or LD (laser diode) made of a nitride semiconductor material capable of emitting output light in the ultraviolet-to-visible wavelength range. In the case of LD, the size of the emission spot can be set to 10 μm or less, and the output light 10a can be narrowed to e.g. a vertical full width at half maximum of 30 degrees and a horizontal full width at half maximum of 10 degrees. This facilitates reliably injecting the light into the optical waveguide body 30.

In this specification, the direction in which the light is guided is defined as light guiding direction (block arrow) 36. The optical waveguide body 30 is transparent and can be made of a transparent material such as transparent resin and glass, or an air layer. For instance, the width of the optical waveguide body 30 can be set to 1.5 mm, and the height can be set to 1.5 mm. The length of the optical waveguide body 30 can be set to e.g. 60 mm.

The light emitting layer 40 includes phosphor particles 41, or a light diffusing agent 42, and is provided so as to enclose the side surfaces 30c, 30f of the optical waveguide body 30. For instance, as shown in FIG. 1B, the phosphor particles 41 are mixed in glass or transparent resin and dispersed along the light guiding direction 36. Alternatively, as shown in FIG. 1C, the light diffusing agent 42 is mixed in glass or transparent resin and disposed in the light guiding direction 36.

The light 10a emitted from the light source 10 is injected into the first end surface 30a of the optical waveguide body 30. The light 10a is incident on the light emitting layer 40 while diverging. The refractive index of the optical waveguide body 30 is preferably made equal to or less than the refractive index of the light emitting layer 40. Then, the light 10a can be effectively injected into the light emitting layer 40. In this case, the thickness of the light emitting layer 40, the phosphor particle concentration, and the light diffusing agent concentration can be suitably selected. Then, the incident light G1, G2 can be totally reflected at the interface between the outer edge 40a of the light emitting layer 40 and air and injected into the first reflection layer 50.

If the phosphor particles are mixed in the entire region of the optical waveguide body, the injected light (excitation light) is absorbed more significantly in the phosphor particles on the light source side, where the intensity of wavelength converted light increases. In this case, temperature increase due to heat generation is higher on the light source side. On the other hand, with the distance from the light source, the intensity of the light decreases, and the intensity of the wavelength converted light also decreases. That is, the light intensity gradually decreases along the light guiding direction.

In contrast, in this embodiment, along the light guiding direction 36, the light 10a can be continuously injected from the optical waveguide body 30 into the light emitting layer 40. Furthermore, the light 10a incident on the second end surface 30b is reflected by the first reflection layer 50. Hence, there is no unnecessary radiation to the outside. The light reflected by the first reflection layer 50 can be injected again into the light emitting layer 40. Thus, the light 10a can be easily reinjected into the light emitting layer 40 uniformly along the light guiding direction 36.

Furthermore, on the first end surface 30a, a second reflection layer 52 may be provided in the region where the light 10a is not injected. Then, also on the first end surface 30a side, unnecessary radiation can be suppressed. Furthermore, a second light source for emitting light having substantially the same wavelength as the light 10a from the first light source 10 may be provided. In this case, the first reflection layer 50 can be provided in the region except the injection region of the light emitted from the second light source.

As shown in FIG. 1B, in the case where the light emitting layer 40 includes phosphor particles 41, the phosphor particle 41 absorbs incident light G3 and emits wavelength converted light. In this case, the wavelength converted light is diffusely emitted while diverging, with the phosphor particle 41 serving as a light emitting source. If the light emitting layer 40 is thin, or the concentration of phosphor particles is not too high, then light gy1 directed toward the optical waveguide body 30 and light gy2 directed outward occur. Part of the light not absorbed by the phosphor particles 41 is, for instance, scattered by or transmitted through the phosphor particles 41. Thus, light gb1 directed toward the optical waveguide body 30 and light gb2 directed outward occur.

As a result, the light from the light source and the wavelength converted light are mixed into outgoing light 80, which is emitted to the outside of the optical waveguide body 30. If the optical waveguide body 30 is shaped like an elongated cylindrical column, the outgoing light 80 can be emitted isotropically in the cross section. If the light 10a is blue laser light and the phosphor particles 41 are made of yellow phosphor containing e.g. silicate, then the outgoing light 80 can be obtained as artificial white light.

FIG. 1C shows the case where the light emitting layer 40 includes a light diffusing agent 42. The incident light G3 is scattered by the light diffusing agent 42. If the light emitting layer including the light diffusing agent 42 has an appropriate diffuse transmittance, light gb1 directed toward the optical waveguide body 30 and light gb2 directed outward are emitted. As a result, outgoing light 80 is emitted in the direction orthogonal to the light guiding direction 36. For instance, if the output light 10a is red laser light, outgoing light 80 of red light is emitted in the direction orthogonal to the light guiding direction 36. Here, the light diffusing agent 42 can be made of particles having high diffuse transmittance, such as polymethyl methacrylate and calcium carbonate.

The light from the light source and the wavelength converted light are not emitted from the second end surface 30b provided with the first reflection layer 50 to the outside of the optical waveguide body 30. Hence, the light extraction efficiency is increased. Furthermore, unnecessary radiation of e.g. laser light is reduced, and safety can be ensured. Thus, this embodiment can provide a light emitting device capable of emitting light efficiently and linearly with sufficient light mixing and uniform chromaticity in a desired region provided with the light emitting layer 40 along the light guiding direction.

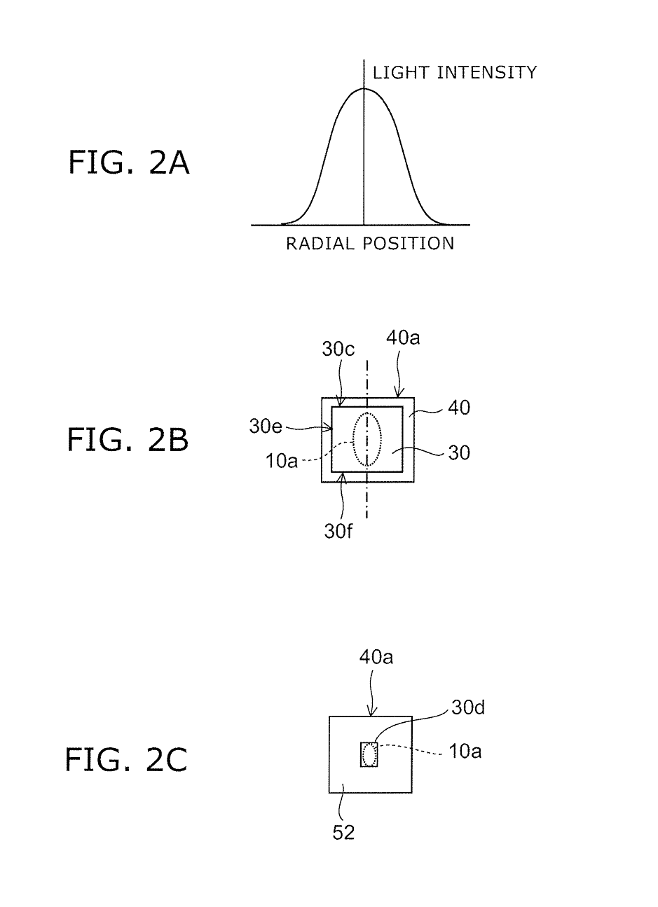

FIG. 2A is a graph showing the light intensity distribution of a laser beam. FIG. 2B is a schematic side view showing an incident surface with a large incident region. FIG. 2C is a schematic side view showing an incident surface with a small incident region.

The light may be obtained by narrowing light from an LED with a convex lens. However, if an LD is used, the light intensity distribution in the beam cross section is Gaussian as shown in FIG. 2A. Hence, 95% or more of the energy can be concentrated in the cross section with the light intensity above 1/e² of the peak value. Thus, the light can be guided with reduced optical loss. Furthermore, in the case of LD, the size of the emission spot can be set to 10 μm or less, and the light 10a can be narrowed to e.g. a vertical full width at half maximum of 30 degrees and a horizontal full width at half maximum of 10 degrees. Thus, a high energy beam can be realized. This enables efficient coupling of energy to the optical waveguide body 30.

In FIG. 2B, the optical waveguide body 30 includes side surfaces 30c, 30e, 30f, 30g. The light (beam) 10a having an elliptical cross section indicated by the dotted line is injected into the first end surface 30a. Alternatively, as shown in FIG. 2C, the light can be injected from a narrow incident region 30d constituting part of the incident surface. In this case, outside the incident region 30d, a second reflection layer 52 can be provided. The second reflection layer 52 can be made of metal or dielectric multilayer film. Although a rectangular cross section is shown in FIGS. 2B and 2C, the cross-sectional shape is not limited thereto. The cross-sectional shape may be circular or elliptical.

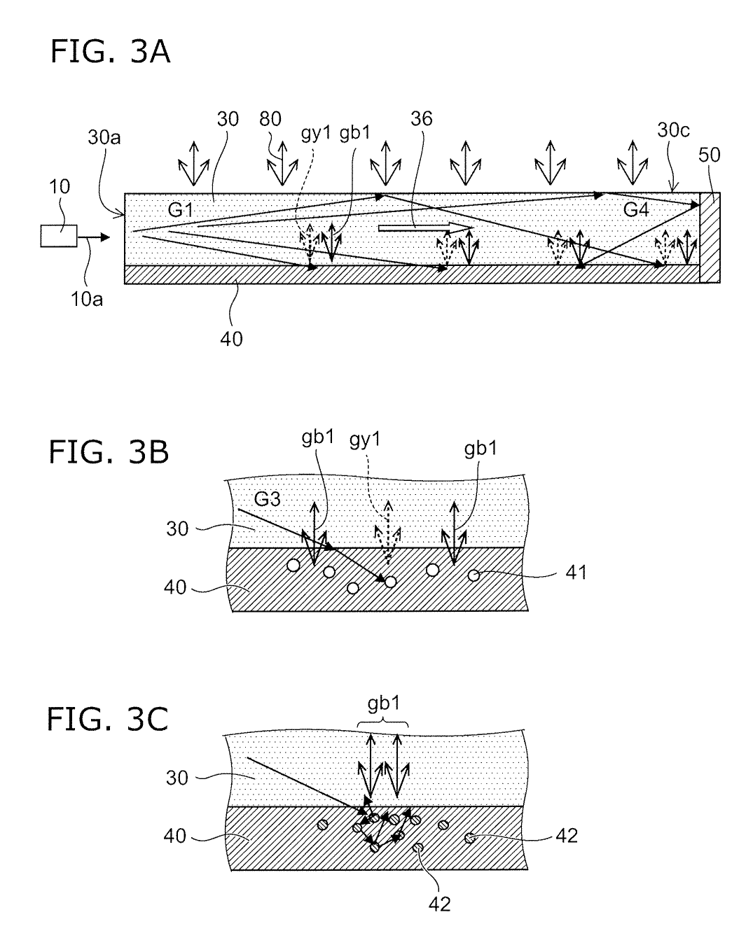

FIG. 3A is a schematic sectional view of a variation of the first embodiment. FIG. 3B is a schematic view showing light emission by phosphor particles. FIG. 3C is a schematic view showing emission by a light diffusing agent.

The side surface 30c of the optical waveguide body 30 is not provided with the light emitting layer. That is, the side surface 30c serves as a light outgoing surface. In this case, at the side surface 30c, the light 10a is totally reflected and guided toward the first reflection layer 50. For instance, incident light G1 is totally reflected by the side surface 30c and then injected into the light emitting layer 40. Incident light G4 is totally reflected by the side surface 30c, then reflected by the first reflection layer 50, and injected into the light emitting layer 40. Thus, light can be injected into the light emitting layer 40 uniformly along the light guiding direction 36.

As shown in FIG. 3B, if the light emitting layer 40 including phosphor particles 41 is made sufficiently thick, or the concentration of phosphor particles 41 is increased, then a large proportion of the wavelength converted light gy1 and light gb1 can be emitted toward the optical waveguide body 30. Furthermore, as shown in FIG. 3C, if the diffuse transmittance of the light diffusing agent 42 is made lower, then a large proportion of the light gb1 can be emitted toward the optical waveguide body 30. As a result, as shown in FIG. 3A, the outgoing light 80 can be emitted toward the light outgoing surface 30c. In this case, in the region from the first end surface 30a to the second end surface 30b, the optical waveguide body 30 acts as a linear light source with sufficient light mixing and uniform chromaticity in a desired region provided with the light emitting layer 40.

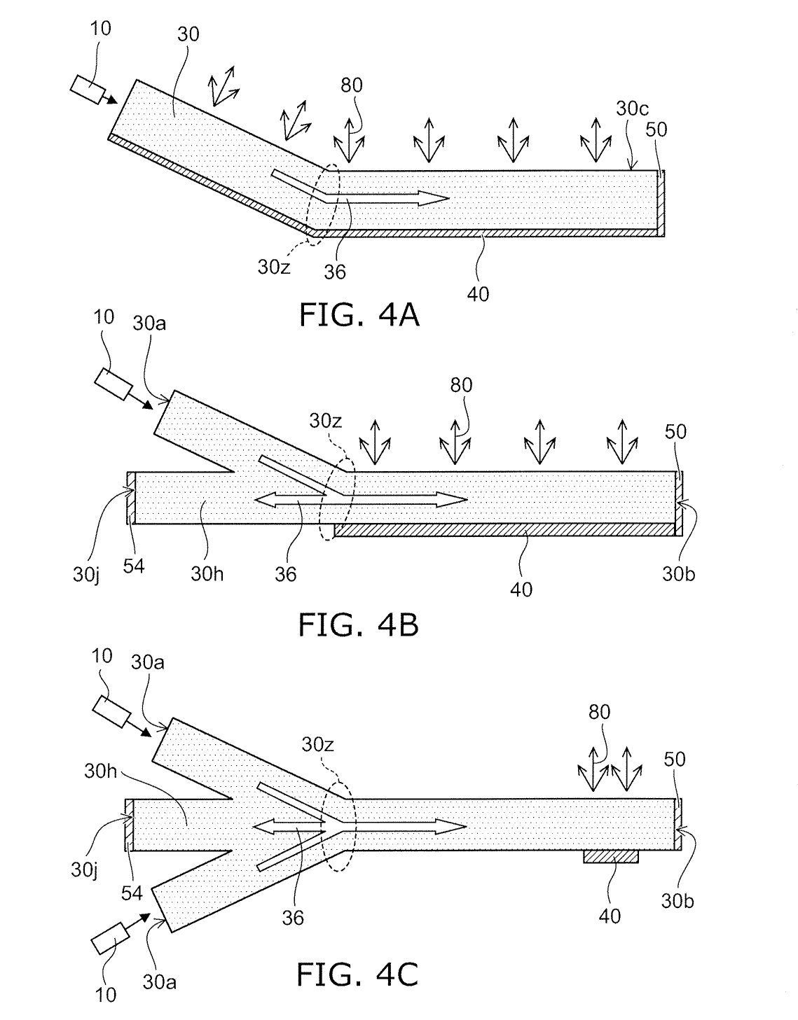

FIG. 4A is a schematic sectional view of a light emitting device according to a second embodiment. FIG. 4B is a schematic sectional view of a light emitting device according to a first variation thereof. FIG. 4C is a schematic sectional view according to a second variation.

In the second embodiment of FIG. 4A, the optical waveguide body 30 includes a bent portion 30z. In the first variation of FIG. 4B, the optical waveguide body 30 includes a branch portion 30h extending from the bent portion 30z toward the opposite side of the second end surface 30b. To the branch portion 30h, the light reflected by the first reflection layer 50 provided on the second end surface 30b side is guided. The branch portion 30h includes a third end surface 30j. The third end surface 30j is provided with a third reflection layer 54. The third reflection layer 54 can further reflect the light reflected by the first reflection layer 50. The third reflection layer 54 can be made of metal or dielectric multilayer film. Thus, also by providing the bent portion 30z, the injected light can be reliably guided in the light guiding direction 36. In the second variation of FIG. 4C, the optical waveguide body 30 includes another region extending from the bent portion 30z. A second light source 10 injects the light 10a into that region. The light emitting layer 40 is provided partly in the light guiding direction 36. Thus, an illumination device capable of emitting light with high brightness can be realized.

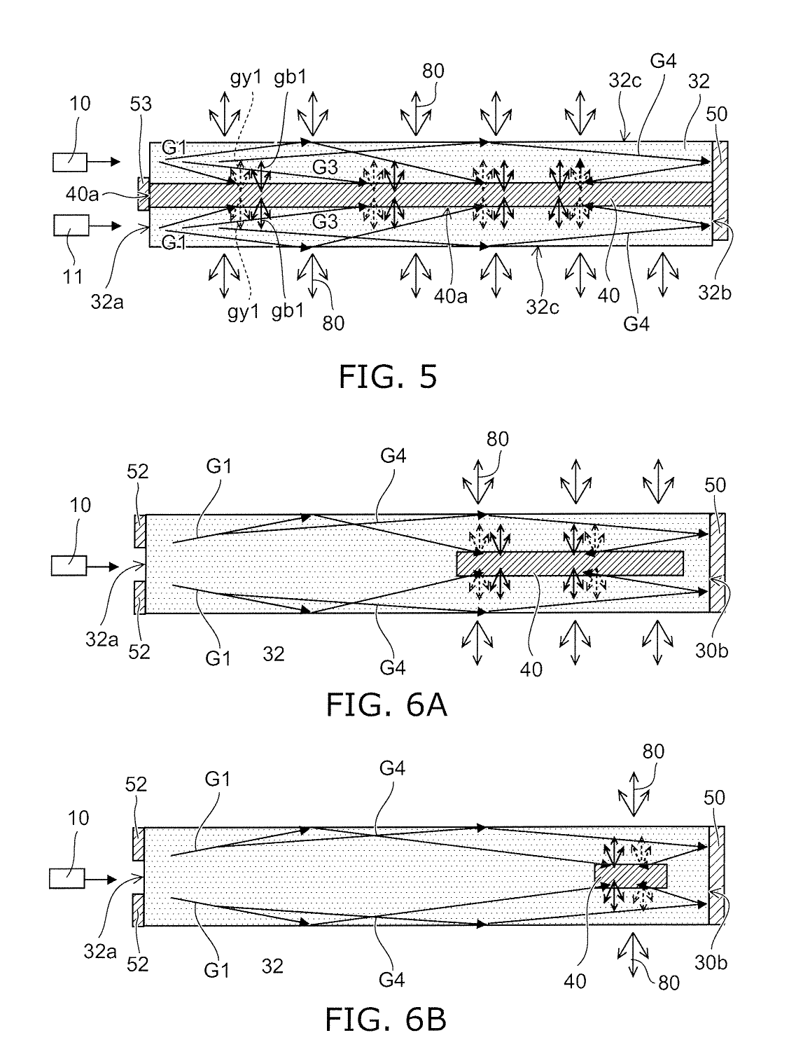

FIG. 5 is a schematic sectional view of a light emitting device according to a third embodiment.

A transparent light emitting layer 40 includes phosphor particles dispersed in resin or glass. An optical waveguide body 32 is provided on the outer edge 40a of the light emitting layer 40. The optical waveguide body 32 is not mixed with phosphor particles and acts as a cladding layer. Here, the refractive index of the light emitting layer 40 can be made higher than the refractive index of the optical waveguide body 32 by e.g. approximately 0.1. Then, the light can be reliably injected into the light emitting layer 40 without total reflection at the interface between the optical waveguide body 32 and the light emitting layer 40.

The light emitting layer 40 and the optical waveguide body 32 can have concentric cross sections shaped like e.g. a circle, ellipse, or rectangle. In this case, light sources having substantially the same wavelength can be arranged with point symmetry to increase the efficacy. The light is injected from the first end surface 32a of the optical waveguide body serving as an incident surface. The second end surface 32b of the optical waveguide body 32 is provided with a first reflection layer 50. The first end surface 40a of the light emitting layer 40 on the side of the first light source 10 and the second light source 11 is provided with a second reflection layer 53. The light emitting layer 40 can have e.g. a length of 10 mm and a diameter of 1.5 mm.

From the interface between the optical waveguide body 32 and the light emitting layer 40, the incident light G3 incident on the light emitting layer 40 having high refractive index gradually penetrates into the light emitting layer 40 including phosphor particles. In this case, the incident light G1, G4 gradually penetrates into the light emitting layer 40 while being totally reflected at the interface between the optical waveguide body 32 and the air layer. The penetrated light is partially absorbed and wavelength converted by the phosphor particles. The rest is emitted from the light outgoing surface 32c by scattering and transmission. Because the second reflection layer 53 is provided, unnecessary radiation from the first end surface 40a of the light emitting layer 40 can be reduced.

FIG. 6A is a schematic sectional view of a light emitting device according to a fourth embodiment. FIG. 6B is a schematic sectional view of a variation thereof.

In FIG. 6A, the light emitting layer 40 is biased to a position near the second end surface 30b of the optical waveguide body 32 as a linear short region like the light emitting portion of a filament light bulb. The length of the light emitting layer 40 shaped like a linear short region can be set to e.g. 3-5 mm. This facilitates efficiently injecting the incident light G1 into the light emitting layer 40 provided near the first reflection layer 50. Alternatively, as shown in FIG. 6B, the light emitting layer 40 may be provided partly in the light guiding direction. Then, a light emitting device with high brightness can be realized.

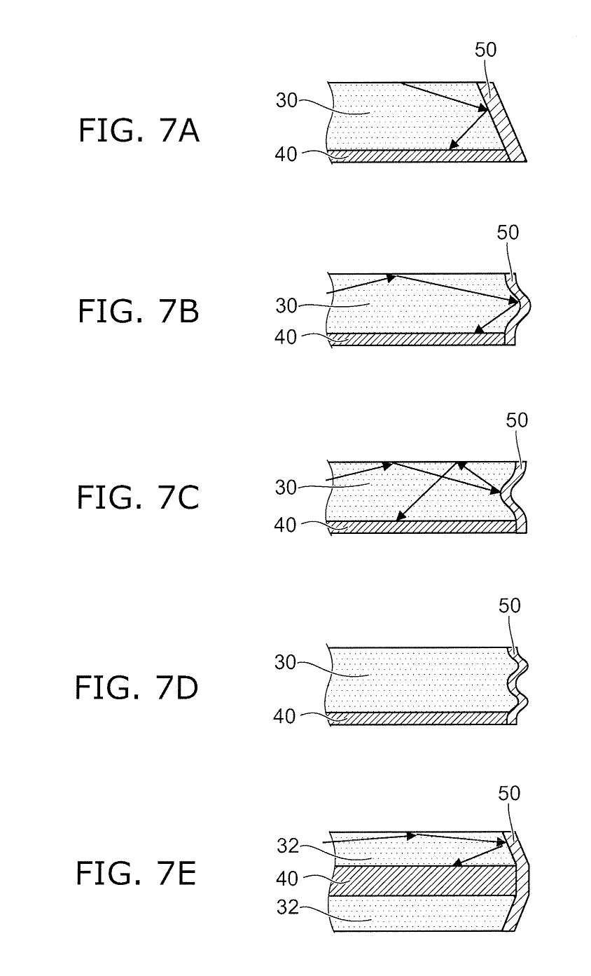

FIGS. 7A to 7E are schematic sectional views showing variations of the shape of the reflection layer.

In FIG. 7A, a planar first reflection layer 50 is provided on the end surface of the optical waveguide body 30 inclined with respect to the light guiding direction. Thus, for instance, the reflected light can be injected more effectively into the light emitting layer 40.

In FIG. 7B, a first reflection layer 50 convex outward is provided. In FIG. 7C, a first reflection layer 50 concave outward is provided. In FIG. 7D, a first reflection layer 50 having a plurality of convex portions is provided. Thus, the reflection direction can be controlled by changing the shape.

In FIG. 7E, the outer peripheral portion of the first reflection layer 50 is bent toward the inside of the optical waveguide body 32. Then, injection into the light emitting layer 40 can be intensified near the second end surface.

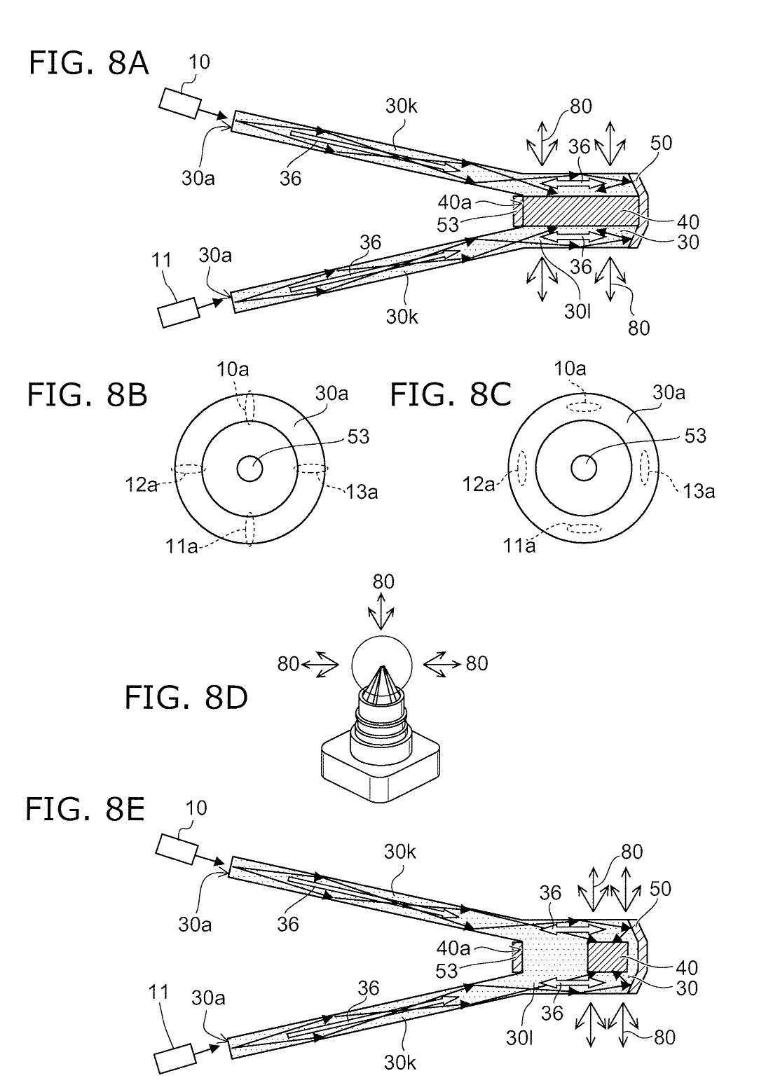

FIG. 8A is a schematic sectional view of a light emitting device according to a fifth embodiment. FIGS. 8B and 8C are schematic side views as viewed from the light source side. FIG. 8D is a schematic perspective view. FIG. 8E is a schematic sectional view of a variation.

As shown in FIG. 8A, the optical waveguide body 30 includes a tip portion 30l and a branch portion 30k branched from the tip portion 30l. The branch portion 30k includes a first end surface 30a on the side of at least two light sources. The tip portion 30l includes a second end surface 30b on the first reflection layer 50 side. In FIGS. 8A to 8E, the branch portion 30k is bent. However, the branch portion 30k may be extended parallel to the light guiding direction 36. If the branch portion 30k is diverged outward as shown in FIGS. 8A to 8E, at least two light sources can be held at a certain distance and easily arranged. This can also enhance heat dissipation. If a second reflection layer 53 is provided on the first end surface 40a of the light emitting layer 40 on the branch portion 30k side, unnecessary radiation can be reduced.

Four output light beams 10a, 11a, 12a, 13a of four respective light sources 10, 11, 12, 13 made of LDs can be injected from the annular first end surface 30a of the branch portion 30k. Then, the polarization direction of the beam can be selected. More specifically, the beam often has an elliptical cross section. Thus, in FIG. 8B, the beam is arranged so that the vertical direction of the beam is directed to the center of the optical waveguide body 30. In FIG. 8C, the beam is arranged so that the vertical direction of the beam is parallel to the circumferential direction. Here, the output light beams from the four light sources 10, 11, 12, 13 have substantially the same wavelength.

FIG. 8D is a schematic perspective view of the light emitting device. The tip portion 30l of the optical waveguide body 30 acts as a filament. More specifically, if the output light is blue laser light and the light emitting layer 40 includes yellow phosphor particles, then outgoing light 80 such as artificial white light can be emitted. Alternatively, if the light is red laser light and the light emitting layer 40 includes a light diffusing agent, then outgoing light 80 of red light can be emitted. In the variation of FIG. 8E, the light emitting layer 40 is provided partly in the light guiding direction 36 in the tip portion 30l. In this case, the second reflection layer 53 may be spaced from the light emitting layer 40.

Such a light emitting device has high emission efficiency and long lifetime, and can be widely used in illumination applications capable of emitting e.g. visible light, white light, or artificial white light. The outgoing light 80 is emitted three-dimensionally from the tip portion 30l. Here, the shape of the branch portion 30k is not limited to an annulus. For instance, four branch portions may be branched from the tip portion 30l. The light sources 10-13 can be arranged at the end portion of the branch portion 30k. This facilitates heat dissipation.

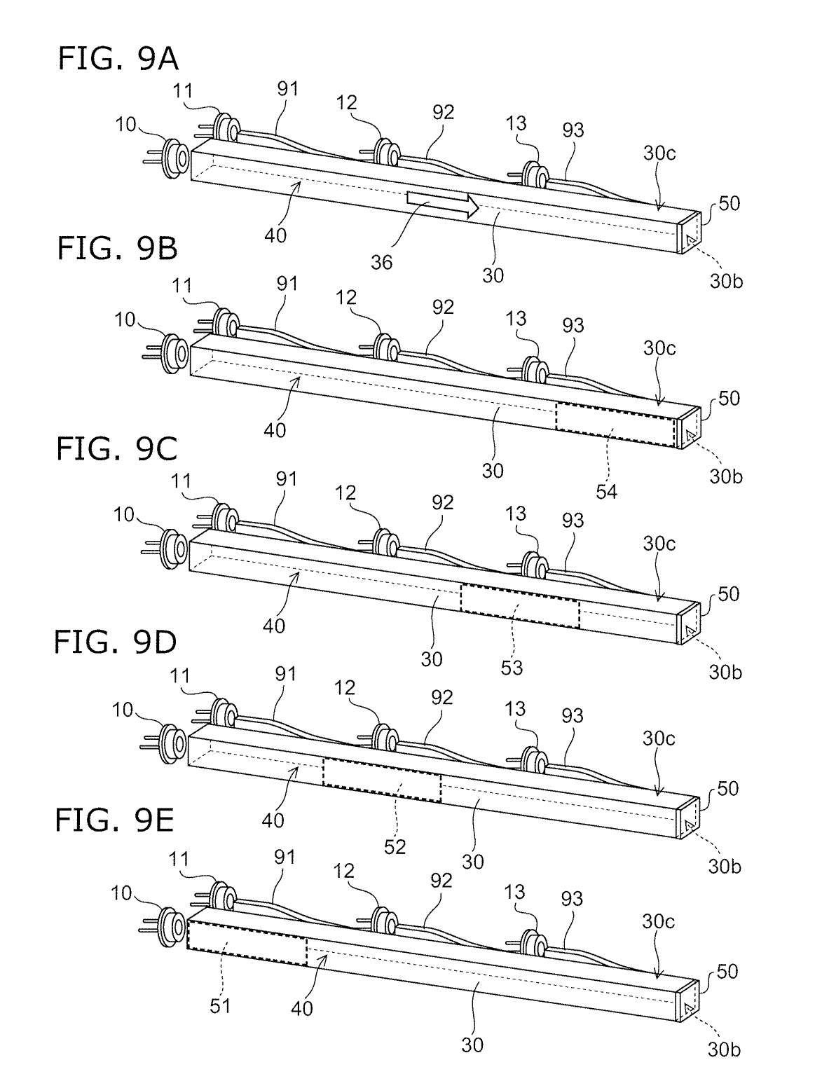

FIG. 9A is a schematic perspective view of a light emitting device according to a sixth embodiment. FIGS. 9B to 9E are schematic views showing the lighting region.

Along one side surface of the optical waveguide body 30, branch portions 91, 92, 93 are provided. The branch portions 91-93 are optically moderately coupled to the optical waveguide body 30. This can impart directivity to the optical coupling. Light sources 11, 12, 13 are provided also on the end surface side of the branch portions 91-93. The light sources 11, 12, 13 can emit three output light beams having substantially the same wavelength as the output light of the first light source 10. Thus, each output light beam is guided toward the second end surface 30b. The second end surface 30b of the optical waveguide body 30 is provided with a first reflection layer 50.

For instance, the first light source 10 and the light sources 11, 12, 13 can be lighted in this order. Then, the light emitting region 51 moves in this order to the light emitting region 54. Thus, a light source with an apparently moving light emitting region can be realized. Here, the order of lighting can be controlled by a driver circuit. If a phosphor-containing layer 46 is provided on the side surface of the optical waveguide body 30, a moving light source of mixed color such as white can be realized.

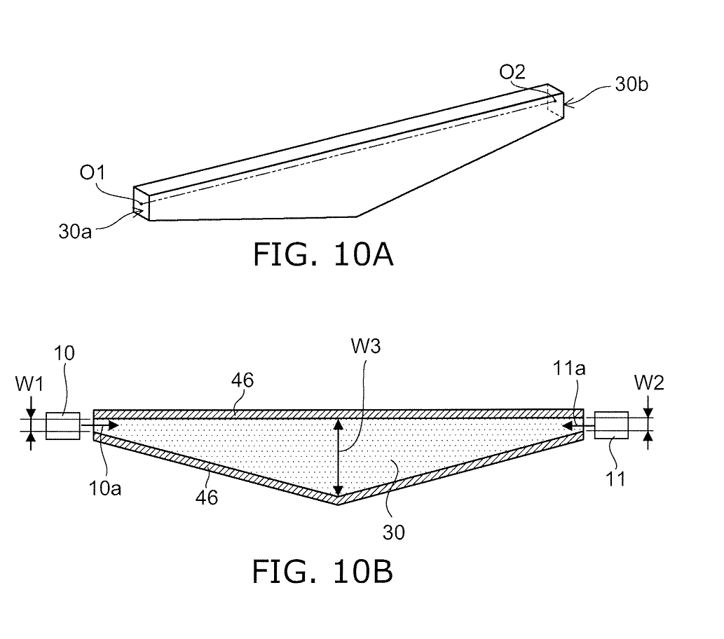

FIG. 10A is a schematic perspective view of a light emitting device according to a seventh embodiment. FIG. 10B is a schematic sectional view thereof.

The light emitting device includes a first light source 10, a second light source 11, a first end surface 30a, a second end surface 30b, and a phosphor-containing layer 46. The wavelength of light emitted from the first light source 10 and the wavelength of light emitted from the second light source are made substantially equal. In the direction orthogonal to the line connecting the center O1 of the first end surface 30a and the center O2 of the second end surface 30b, the width W3 of the central portion of the optical waveguide body 30 is wider than each of the width W1 of the first end surface 30a and the width W2 of the second end surface 30b.

Thus, the light injected from one end surface is gradually spread and absorbed by the phosphor-containing layer 46 narrowed toward the other end surface. Hence, light can be emitted in the direction orthogonal to the line O1-O2 while keeping the emission intensity uniform along the line O1-O2. Furthermore, the loss of the output light can be reduced, and unnecessary radiation from the first end surface 30a and the second end surface 30b to the outside can be reduced. The light emitting device according to the seventh embodiment can be used for e.g. back light sources of the edge light type, vehicle-mounted head/fog lamp light sources, and general illumination.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A light emitting device comprising:
a first light source;
an optical waveguide body including a first end surface to which light from the first light source is injected, and a second end surface opposed to the first end surface and provided in a light guiding direction of the injected output light;
a light emitting layer including, along the light guiding direction, phosphor particles capable of absorbing the light and emitting wavelength converted light or a light diffusing agent diffusing the output light; and
a first reflection layer provided on the second end surface and being capable of reflecting part of the light guided in the optical waveguide body,
diffused light from the light emitting layer being emitted to outside of the optical waveguide body.

2. The device according to claim 1, further comprising:
a second reflection layer provided on a region of the first end surface where the light is not injected.

3. The device according to claim 2, further comprising:
a third reflection layer capable of reflecting light reflected from the first reflection layer,
the optical waveguide body including a bent portion and a branch portion extending from the bent portion toward opposite side of the second end surface, and
the third reflection layer being provided on an end surface of the branch portion.

4. The device according to claim 1, further comprising:
a second light source provided on the first end surface side or the second end surface side and emitting output light having a wavelength substantially equal to wavelength of the output light from the first light source.

5. The device according to claim 1, further comprising:
a second light source,
the optical waveguide body including a branch portion capable of introducing light from the second light source toward the second end surface.

6. The device according to claim 1, wherein
the optical waveguide body is provided so as to enclose an outer edge of the light emitting layer, and
refractive index of the optical waveguide body is equal to or less than refractive index of the light emitting layer.

7. The device according to claim 1, wherein the light emitted from the first light source is semiconductor laser light in which vertical full width at half maximum is larger than horizontal full width at half maximum.

8. A light emitting device comprising:
a first light source;
a second light source;
an optical waveguide body including a tip portion and a branch portion branched and extending from the tip portion, the optical waveguide body including a first end surface including regions to which lights from the first and second light sources are respectively injected, and a second end surface opposed to the first end surface and provided in a light guiding direction of the lights;
a light emitting layer including, along the light guiding direction, phosphor particles capable of absorbing the lights from the first and second light sources and emitting corresponding wavelength converted light or a light diffusing agent diffusing the output light, the light emitting layer being surrounded with the tip portion; and
a first reflection layer provided on the second end surface and being capable of reflecting part of the output light guided in the optical waveguide body,
diffused light from the light emitting layer being emitted to outside of the optical waveguide body.

9. The device according to claim 8, further comprising:
a second reflection layer provided on an end surface of the tip portion so as to be opposed to the second end surface.

10. The device according to claim 9, wherein the light emitting layer is provided in contact with each of the first reflection layer and the second reflection layer.

11. The device according to claim 9, wherein the light emitting layer is spaced from each of the first reflection layer and the second reflection layer.

12. The device according to claim 8, wherein the light emitted from the first light source is semiconductor laser light in which vertical full width at half maximum is larger than horizontal full width at half maximum.

13. The device according to claim 12, wherein vertical direction of the light is directed to center of the optical waveguide body.

14. The device according to claim 12, wherein horizontal direction of the light is directed to center of the optical waveguide body.

15. The device according to claim 8, wherein wavelength of the light emitted from the first light source is substantially equal to wavelength of the light emitted from the second light source.

16. A light emitting device comprising:
a first light source;
a second light source;
an optical waveguide body including a first end surface to which light from the first light source is injected, and a second end surface to which light from the second light source is injected, the second end surface being provided on opposite side of the first end surface; and
a light emitting layer extending between the first end surface and the second end surface and including, along the light guiding direction, phosphor particles capable of absorbing the light emitted from the first light source and the light emitted from the second light source and emitting corresponding wavelength converted light or a light diffusing agent diffusing the light from the first light source and the light from the second light source,
in a direction orthogonal to a line connecting center of the first end surface and center of the second end surface, width of a central portion of the optical waveguide body being wider than each of width of the first end surface and width of the second end surface, and
the light from the first light source and the light from the second light source being converted to diffused light and emitted to outside of the optical waveguide body.

17. The device according to claim 16, wherein
the light from the first light source is semiconductor laser light in which vertical full width at half maximum is larger than horizontal full width at half maximum, and
the light from the second light source is semiconductor laser light in which vertical full width at half maximum is larger than horizontal full width at half maximum.

18. The device according to claim 16, wherein wavelength of the light from the first light source is substantially equal to wavelength of the light from the second light source.

19. The device according to claim 16, wherein vertical direction of the light from the first light source and vertical direction of the light from the second light source are parallel to a direction in which the width of the optical waveguide body is changed, respectively.
